(19) United States
(12) Patent Application Publication
(10) Pub. No.: US 2018/0345462 A1
(43) Pub. Date: Dec. 6, 2018

(54) TOOL ATTACHMENT

(71) Applicant: Chih-Ming Lee, Taichung (TW)

(72) Inventor: Chih-Ming Lee, Taichung (TW)

(21) Appl. No.: 15/611,808

(22) Filed: Jun. 2, 2017

(51) Int. Cl. B25B 17/00; B25B 13/48; B25B 23/00

(52) U.S. Cl. CPC B25B 17/00; B25B 23/0007; B25B 13/481

(57) ABSTRACT

A tool attachment includes a first body, a first gear, a second gear, at least one third gear, a cover, multiple bolts and multiple tools. The at least one third gear is engaged with the first and second gears. When either one of the first and second gears rotates, the first gear, the second gear and the at least one third gear rotates together. The tools can be connected to the tool attachment as needed.

### BACKGROUND OF THE INVENTION

### 1. Fields of the Invention

The present invention relates to a tool attachment, and more particularly, to a tool attachment that is designed to be connected with multiple tools.

### 2. Descriptions of Related Art

The conventional tool attachment known to applicant is disclosed in U.S. Pat. No. 4,279,314, and comprises a housing having an internal compartment, an access opening formed within the housing connecting with the internal compartment; a primary drive gear rotatably mounted within the internal compartment, the primary drive gear having a socket opening centrally located within the primary drive gear, the socket opening connecting with the access opening; a secondary drive gear rotatably mounted within the internal compartment, the secondary drive gear being operatively connected through an idler gear to the primary drive gear; a spring assembly connected to both the primary and the secondary drive gears, the spring assembly being windable by rotating the socket opening, the socket opening to connect with a socket plug, the spring assembly to cause rotation of the socket plug; and a movable pawl mounted on the housing and located within the internal compartment, the movable pawl being movable between an engaging position and a disengaging position, the engaging position connecting the movable pawl with one of the drive gears and preventing rotation of the socket opening by the spring assembly.

Nevertheless, the attachment has a limited length and interior space, and the idler gear, the secondary drive gear and the socket sleeve are all received in the attachment. When using a wrench to rotate the socket plug, the significant torque generated by the wrench makes the user difficult to well hold the attached, so that the attachment will rotate with the wrench. The attachment can only be connected with a wrench. The length is too short of the attachment so that it is inconvenient for the user to rotate it.

The present invention intends to provide a tool attachment to eliminate the shortcomings mentioned above.

### SUMMARY OF THE INVENTION

The present invention relates to a tool attachment and comprises a first body, a first gear, a second gear, at least one third gear, a cover, multiple bolts and multiple tools. The at least one third gear is engaged with the first and second gears. When either one of the first and second gears rotates, the first gear, the second gear and the at least one third gear rotates together. The tools can be connected to the tool attachment as needed.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the tool attachment of the present invention;

FIG. 2 is a top view of the first body of the tool attachment of the present invention;

FIG. 3 is a perspective view to show the tool attachment of the present invention;

FIG. 4 shows different tools and the tool attachment of the present invention;

FIG. 5 is an exploded view of the fifth tool unit of the tool attachment of the present invention;

FIG. 6 is a perspective view of the fifth tool unit of the tool attachment of the present invention;

FIG. 7 is a side view of the fifth tool unit of the tool attachment of the present invention;

FIG. 8 is a side view of an operational status of the fifth tool unit of the tool attachment of the present invention;

FIG. 9 shows the first operational status of the tool attachment of the present invention;

FIG. 10 shows the second operational status of the tool attachment of the present invention;

FIG. 11 shows the third operational status of the tool attachment of the present invention;

FIG. 12 shows the fourth operational status of the tool attachment of the present invention;

FIG. 13 shows the second embodiment of the tool attachment of the present invention;

FIG. 14 shows the third embodiment of the tool attachment of the present invention;

FIG. 15 is an exploded view of the fourth embodiment of the tool attachment of the present invention;

FIG. 16 is a perspective view to show the fourth embodiment of the tool attachment of the present invention;

FIG. 17 is an exploded view of the fifth embodiment of the tool attachment of the present invention, and

FIG. 18 is a perspective view to show the fifth embodiment of the tool attachment of the present invention.

### DETAILED DESCRIPTION OF THE PREFERRED EMBODIMENT

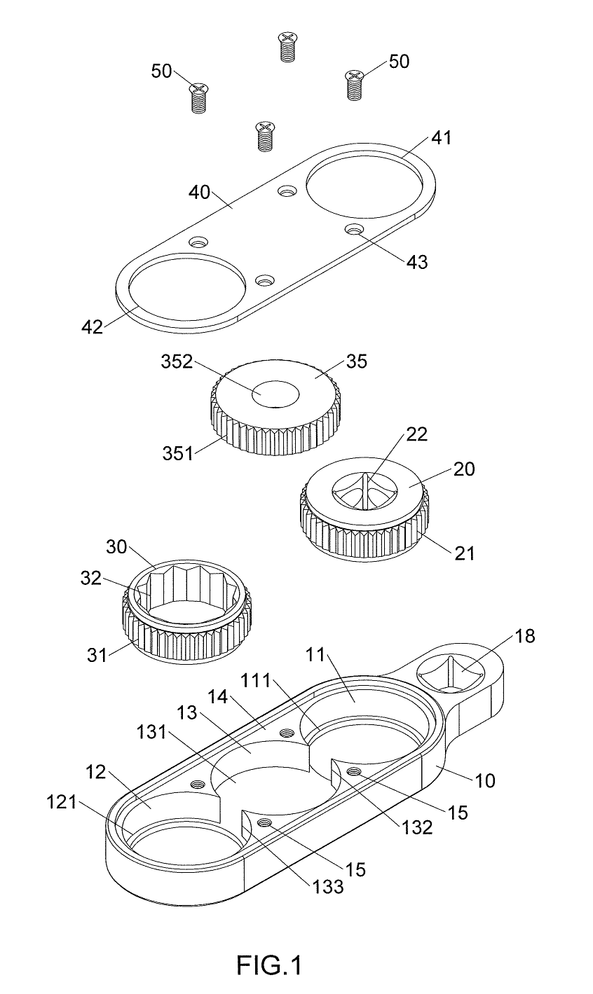

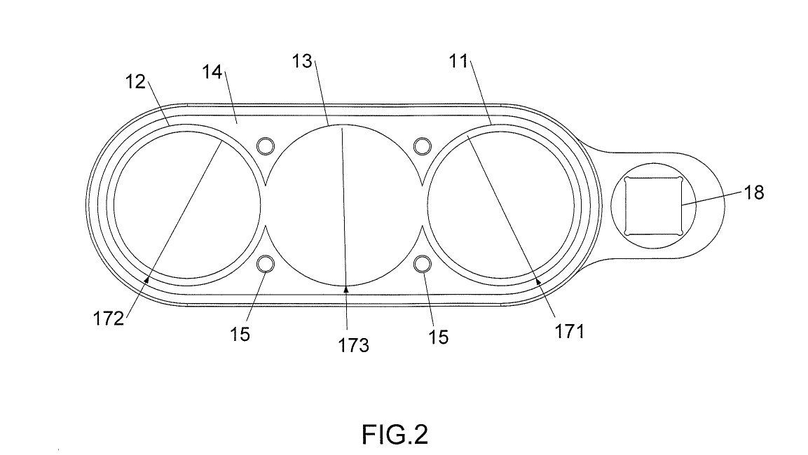

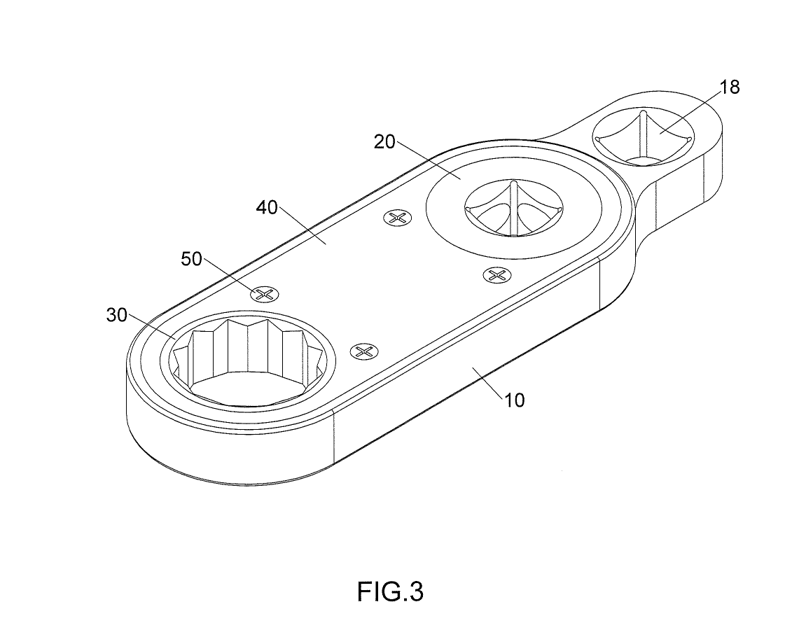

Referring to FIGS. 1 to 3, the tool attachment of the present invention comprises a first body 10, a first gear 20, a second gear 30, at least one third gear 35, a cover 40 and multiple bolts 50. The first body 10 has a first recess 11, a second recess 12 and at least one third recess 13 which is located between and in communication with the first and second recesses 11, 12. The first and second recesses 11, 12 are round and defined through the first body 10. The first recess 11 includes a first flange 111, and the second recess 12 has a second flange 112 extending inward form the inner periphery thereof. The at least one third recess 13 includes a closed end 131. The at least one third recess 13 communicates with the first and second recesses 11, 12 respectively by a first opening 132 and a second opening 133. The first body 10 includes a recessed area 14 defined in the top thereof, and the recessed area 14 communicates with the first and second recesses 11, 12, the at least one third recess 13 and the first and second openings 132, 133. Multiple threaded holes 15 defined in the recessed area 14. The diameter 171 of the first recess 11, the diameter 172 of the second recess 12, and the diameter 173 of the at least one third recess 13 are the same. The first body 10 has a rectangular first connection portion 18 which is located close to the first recess 11 and located remote from the second recess 12.

The first gear 20 is rotatably received in the first recess 11 and rested on the first flange 111. First teeth 21 are defined in the outer periphery of the first gear 20. A first mounting hole 22 is defined in the center thereof. The second gear 30 is rotatably received in the second recess 12 and rested on the second flange 121. The second gear 30 has second teeth 31 defined in the outer periphery thereof. A second mounting hole 32 which includes twelve corners is defined in the center thereof. The at least one third gear 35 is rotatably received in the at least one third recess 13 and rested on the closed end 131, and has third teeth 351 defined in the outer periphery thereof. The third teeth 351 are engaged with the first and second teeth 21, 31 via the first and second openings 132, 133 so that the first gear 21 drives the second gear 30 via the at least one third gear 35. An axial hole 352 is defined in the center thereof and the axial hole 352 is a round hole. The first gear 20, the second gear 30 and the third gear 35 have an identical outer diameter. The cover 40 is engaged with the recessed area 14 and mounted to the first body 10 by the multiple bolts 50 so as to position the first gear 20, the second gear 30 and the at least one third gear 35 in the first body 10. The cover 40 includes first hole 41 and a second hole 42. The first mounting hole 22 and the second mounting hole 32 are exposed from the first body 10 via the first and second holes 41, 42. The middle portion of the cover 40 seals the third gear 35 and hides the third gear 35 in the first body 10. The cover 40 includes multiple locking holes 43 which are located corresponding to the threaded holes 15. The respective tops of the first body 10, the cover 40, the first gear 20 and the second gear 30 are in flush with each other. The bolts 50 extend through the locking holes 43 and are connected to the threaded holes 15 to fix the cover 40 to the first body 10, and the periphery of each of the first and second gears 20, 30 are respectively in contact with the periphery of the first and second holes 41, 42. The at least one third gear 35 is hidden by the cover 40. When the first gear 20 is applied by a force to rotate, the at least one third gear 35 is rotated so as to drive the second gear 30 to rotate.

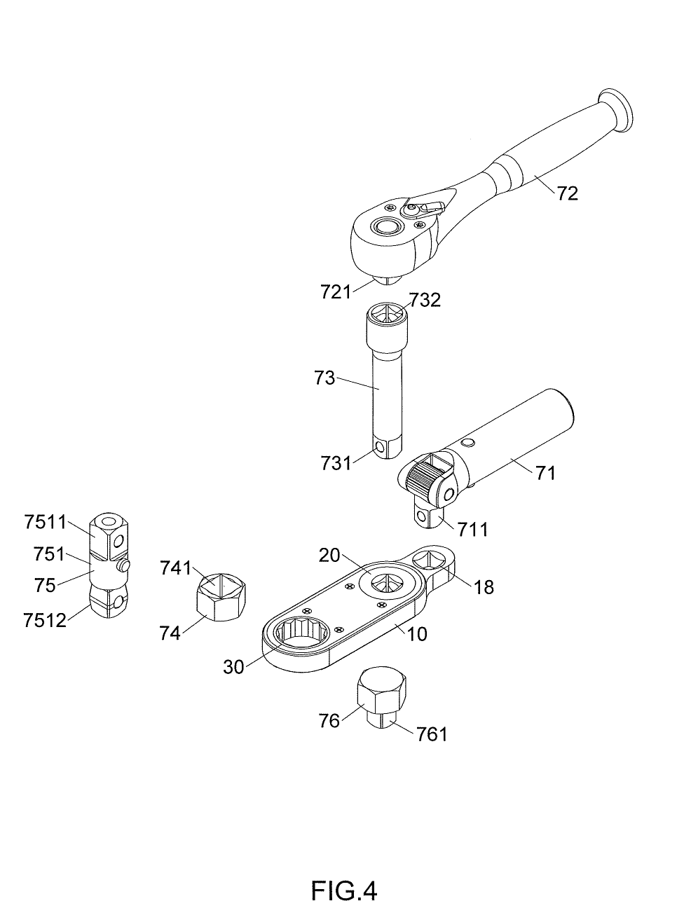

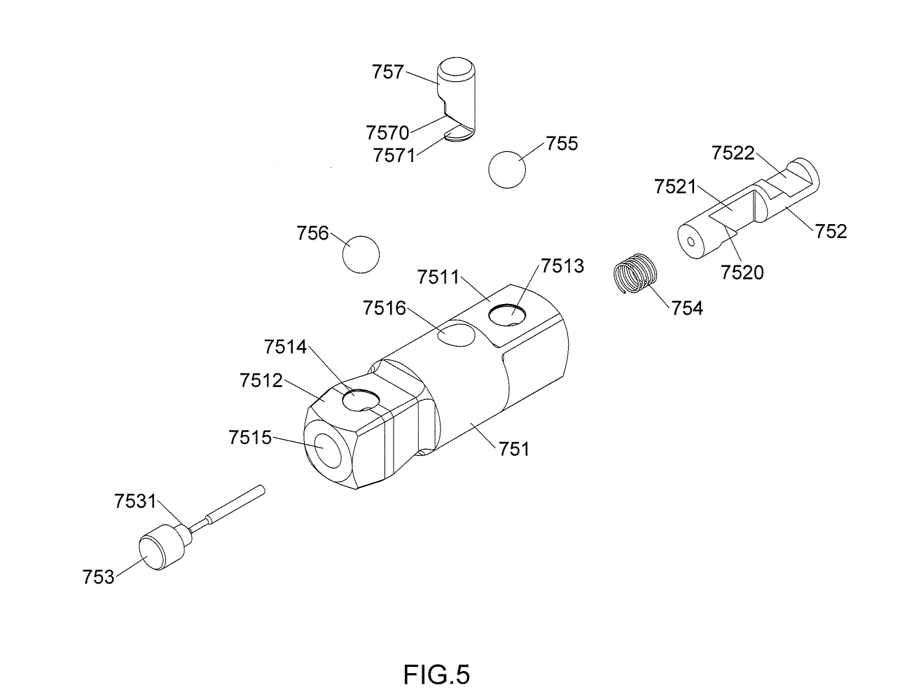

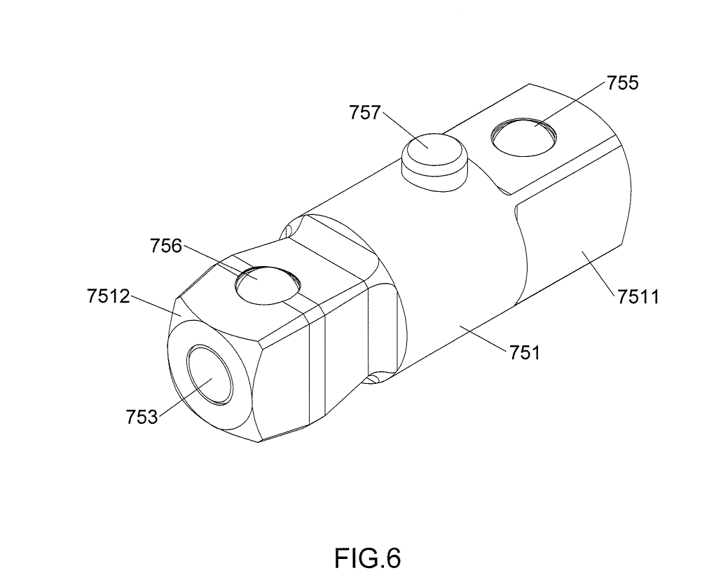

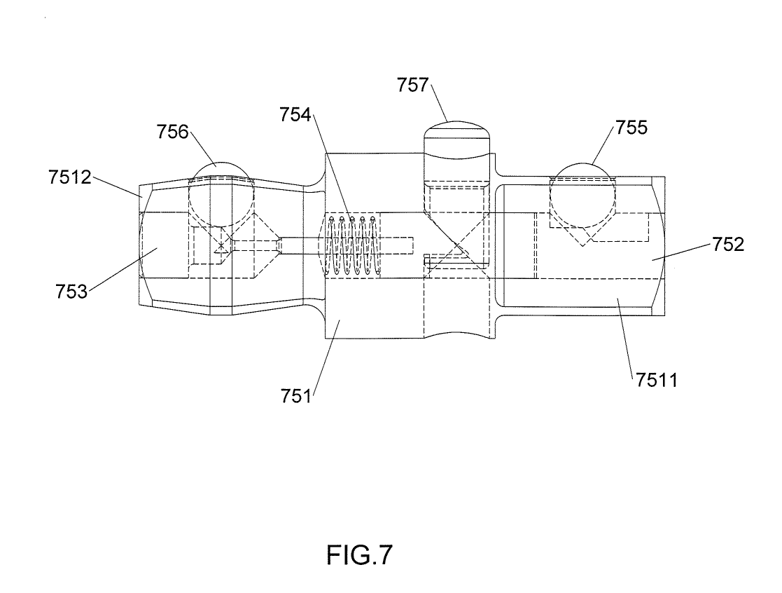

As shown in FIGS. 4 to 8, there are an elongate first tool 71, a second tool 72, an elongate third tool 73, a hexagonal fourth tool 74, a fifth tool unit 75, and a sixth tool 76 are able to be connected with the first body 10. The first tool 71 has a rectangular first engaging portion 711 formed on the first end thereof, and the first engaging portion 711 is engaged with the first connection portion 18 so as to have a long arm to easily rotate the first body 10 to output torque. The first engaging portion 711 and the first tool 71 form an F-shaped arrangement. The second tool 72 has a rectangular second engaging portion 721 which is cooperated with a ratchet unit. The third tool 73 has a rectangular third engaging portion 731 on the first end thereof, and the third engaging portion 731 connected to the first mounting hole 22 of the first body 10. A rectangular recess 732 is defined in the second end of the third tool 73 and connected with the second engaging portion 721. The hexagonal fourth tool 74 is connected to the second mounting hole 32 and has a rectangular fourth engaging portion 741. The fourth tool 74 and the second gear 30 has the same thickness. The fifth tool unit 75 is connected to the fourth tool 74 and is a connector.

The fifth tool unit 75 includes a fifth tool 751, a first pin 752, a second pin 753, a spring 754, a first bead 755, a second bead 756 and a push member 757. The fifth tool 751 has a rectangular fifth engaging portion 7511 on the first end thereof, and the fifth engaging portion 7511 is connected to the fourth engaging portion 741. The fifth tool 751 has a rectangular sixth engaging portion 7512 on the second end thereof. The fifth engaging portion 7511 includes a first bead hole 7513, and the sixth engaging portion 7512 includes a second bead hole 7514 and a first receiving portion 7515. The first receiving portion 7515 communicates with the first bead hole 7513 and the second bead hole 7514. The fifth tool 751 includes a through hole 7516 located between the first bead hole 7513 and the second bead hole 7514. The axis of the through hole 7516 is perpendicular to the axis of the first receiving portion 7515. The first pin 752 movably extends through the first receiving portion 7515. The first pin 752 has a first receiving recess 1571 in the first end thereof and the first receiving recess 1571 is located corresponding to the through hole 7516 of the fifth tool 751. A first notch 7522 is defined in the second end of the first pin 752. The first receiving recess 7521 opens laterally and has an inclined end face. The second pin 753 extends through the first receiving portion 7515 and is engaged with the first pin 752. When the first pin 752 moves in the fifth tool 751, the second pin 753 is driven to move by the first pin 752. The second pin 753 includes a second notch 7531 defined in the first end thereof. The spring 754 is located in the first receiving portion 7515 and biased between the first receiving portion 7515 and the first pin 752. The first bead 755 is located in the first bead hole 7513 and contacts the first pin 752. The first bead 755 partially protrudes beyond the first bead hole 7513. The second bead 756 is located in the second bead hole 7514 and contacts the second pin 753. The second bead 756 partially protrudes beyond the second bead hole 7514. The push member 757 is inserted into the through hole 7516 of the fifth tool 751 and engaged with the first pin 752. The push member 757 includes a second receiving recess 7571 which contacts the first receiving recess 7521. The second receiving recess 7571 has an inclined face 7570 which is in contact with the inclined face 7520 of the first receiving recess 7521. The push member 757 has one end thereof protruding beyond the through hole 7516 of the fifth tool 751.

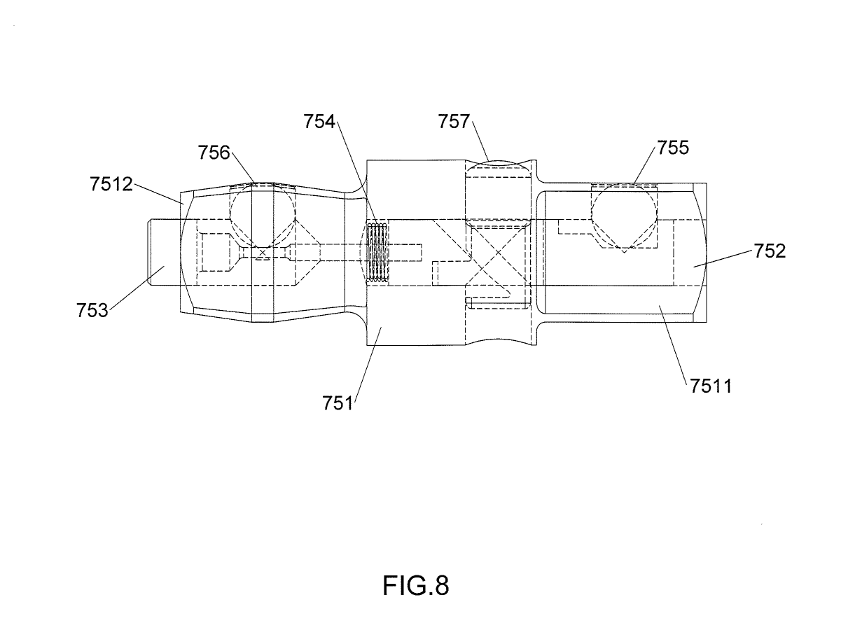

As shown in FIG. 8, when the push member 757 is pushed, the second receiving recess 7571 pushes the first receiving recess 7521, and the first pin 752 drives the second pin 753 to move in the fifth tool 751, and the spring 754 is compressed, the first bead 755 is received in the first notch 7522 and submerged in the first bead hole 7513. The second bead 756 is received in the second notch 7531 and submerged in the second bead hole 7514. The second pin 753 has one end protruding beyond the first receiving portion 7515. The sixth engaging portion 7512 is connected to or dis-connected from a tool. The fifth engaging portion 7511 is separated from the fourth engaging portion 741.

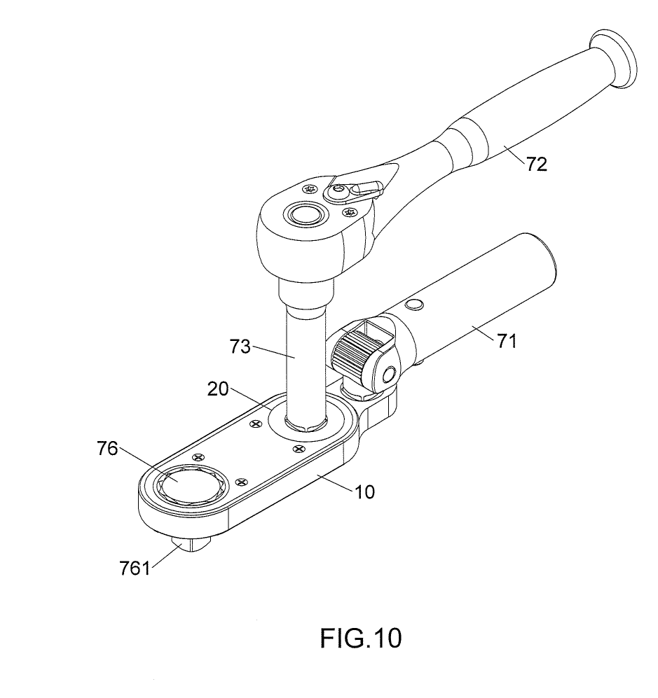

As shown in FIGS. 4 and 10, the sixth tool 76 is connected to the second mounting hole 32 of the second gear 30 and has a seventh engaging portion 761 protruding therefrom. The sixth tool 76 is a connector. The rectangular seventh engaging portion 761 protrudes from the first body 10.

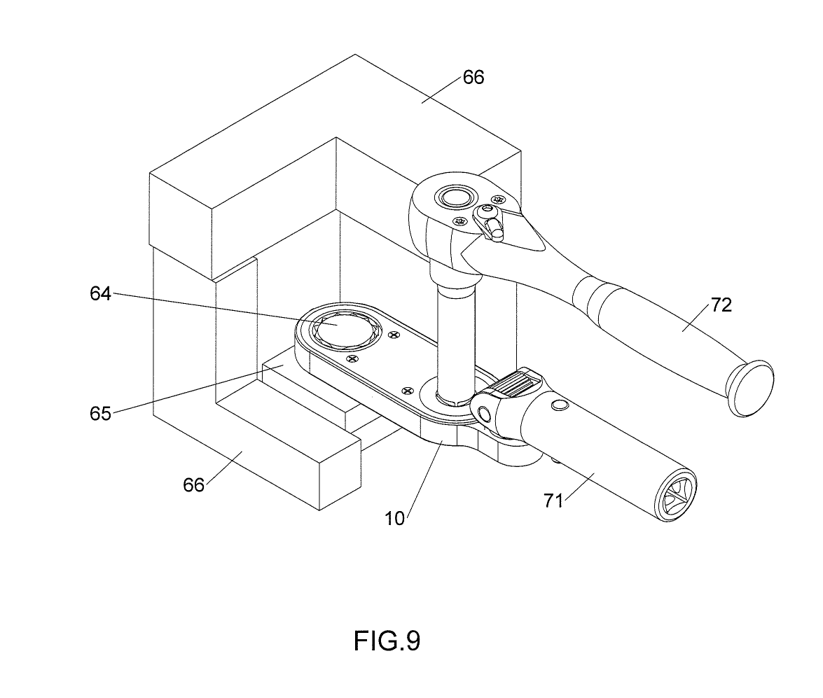

As shown in FIGS. 4 and 9, when the user wants to pick out a threaded member 64 connected to the first object 65, and the threaded member 64 is blocked by a second object 66, the user may connect the first engaging portion 711 to the first connection portion 18. The third engaging portion 731 is connected to the first mounting hole 22, and the rectangular recess 732 is connected to the second engaging portion 721. The second tool 72 is rotated, the first gear 20 drives the at least one third gear 35 and the second gear 30 such that the threaded member 64 is removed.

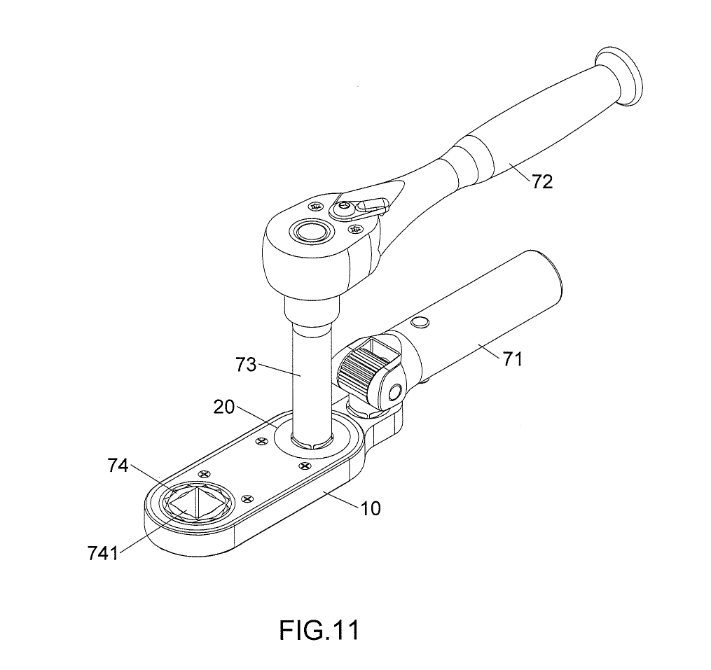

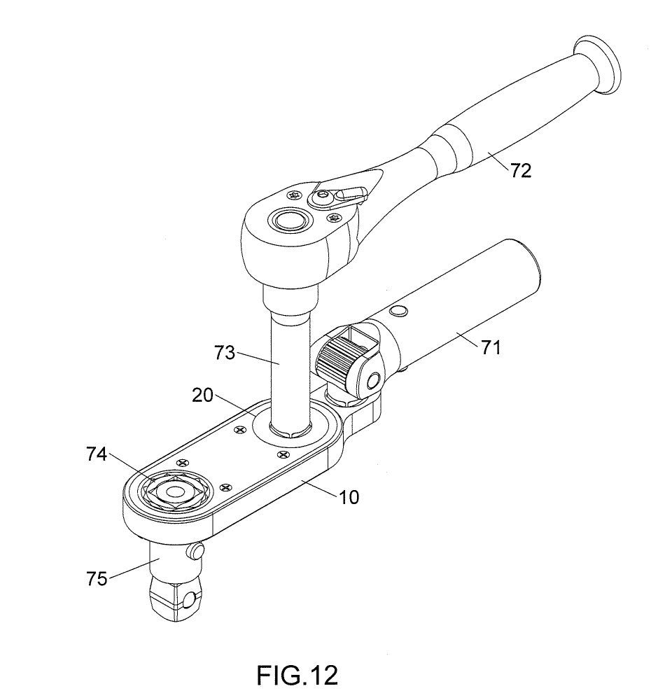

As shown in FIGS. 10 to 12, the first engaging portion 711 is connected to the first connection portion 18. The third tool 73 is connected to the first gear 20 and the second tool 72. The third engaging portion 731 is connected to the first mounting hole 22, and the rectangular recess 732 is connected to the second engaging portion 721. Therefore, the first body 10 is cooperated with different tools. The second mounting hole 32 can be connected with the fourth tool 74, or the sixth tool 76. The fourth engaging portion 741 can be connected with a tool with a rectangular protrusion such as the fifth tool unit 75. The seventh engaging portion 761 protrudes beyond the second gear 30 and is connected with the tool with the rectangular recess as shown in FIG. 10. When the second tool 72 is rotated, the third tool 73 drives the first gear 20 which drives the at least one third gear 35 and the second gear 30. The second gear 30 drives the fourth tool 74, the fifth tool unit 75 or the sixth tool 76 at the second mounting hole 32 to rotate.

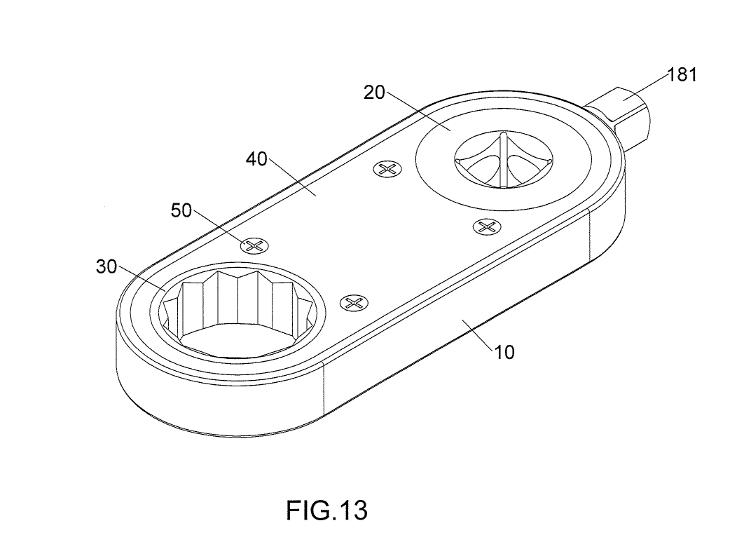

As shown in FIG. 13, the first body 10 has a rectangular protrusion 181 extending therefrom which can be connected with an extension rod.

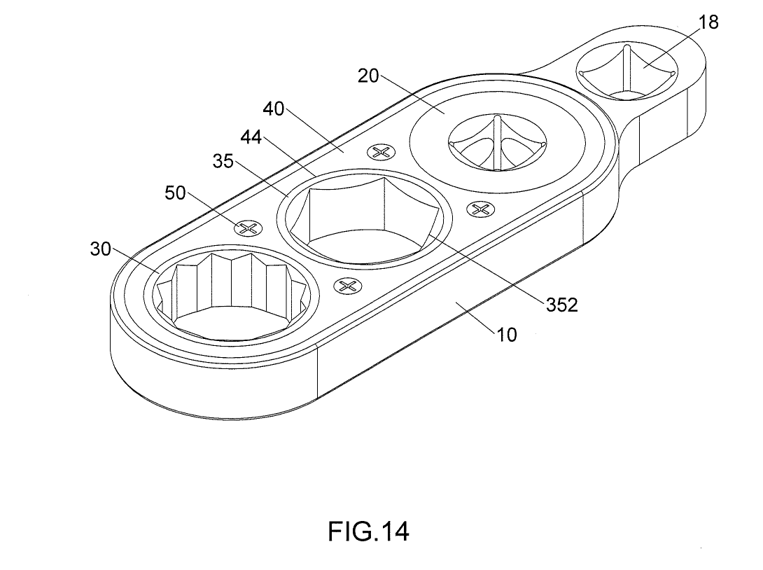

As shown in FIG. 14, the at least one third recess 13 is defined through the first body 10. The axial hole 352 is a hexagonal hole. The cover 40 includes a third hole 44 which is located corresponding to the at least one third recess 13 so that the axial hole 352 is exposed.

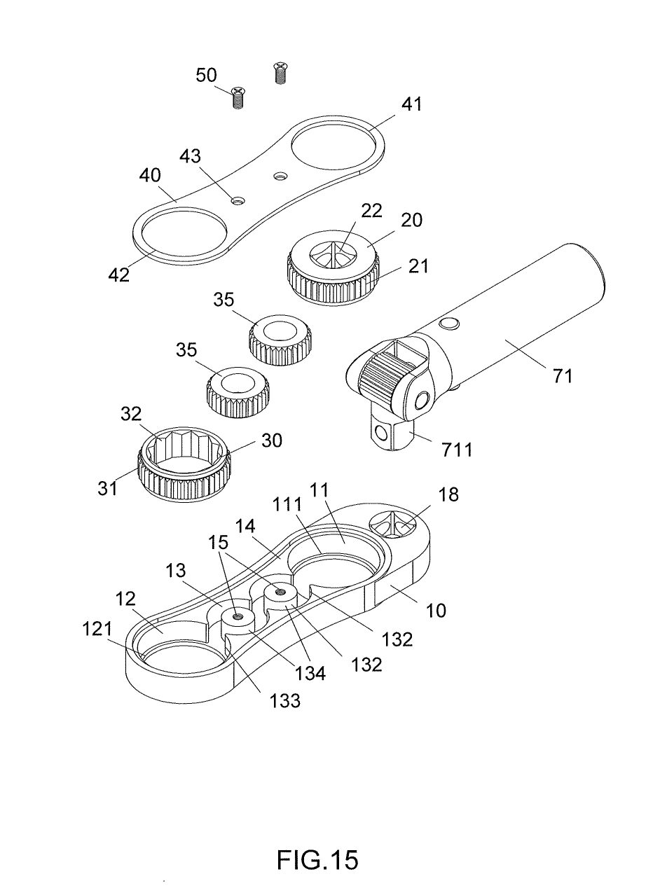

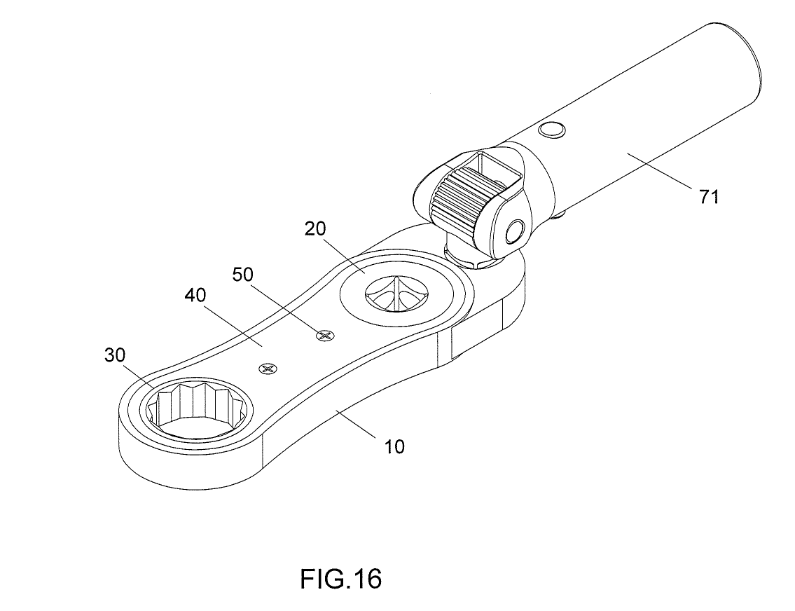

As shown in FIGS. 15 and 16, there are two third recesses 13. The diameter 173 of each of the third recesses 13 is smaller than the diameter 171 of the first recess 11 and the diameter 172 of the second recess 12. Two tubular pivotal members 134 respectively extend from the two third recesses 13. The threaded hole 15 are defined in the two tubular pivotal members 134. Each third recess 13 receives a third gear 35. The two third gears 35 are mounted to the two pivotal members 134. The third teeth of the two third gears 35 are engaged with the first teeth 21 of the first gear 20 and the second teeth 31 of the second gear 30. The third teeth of the two third gears 35 are engaged with each other. The locking holes 43 are located corresponding to the threaded holes 15, the bolts 50 extend through the locking holes 43 and are connected to the threaded holes 15 to fix the cover 40 to the recessed area 14.

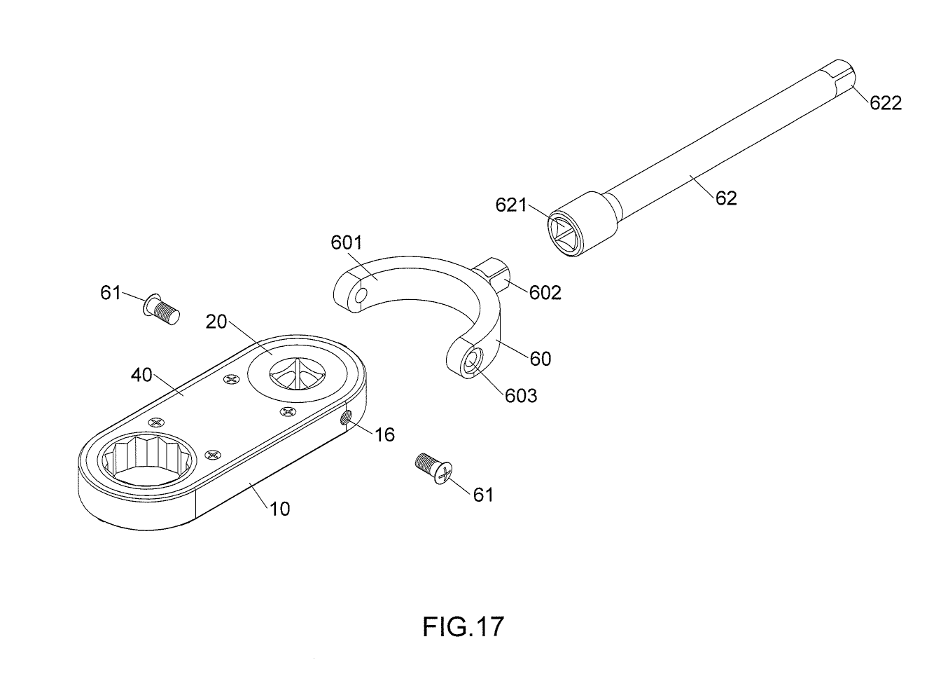

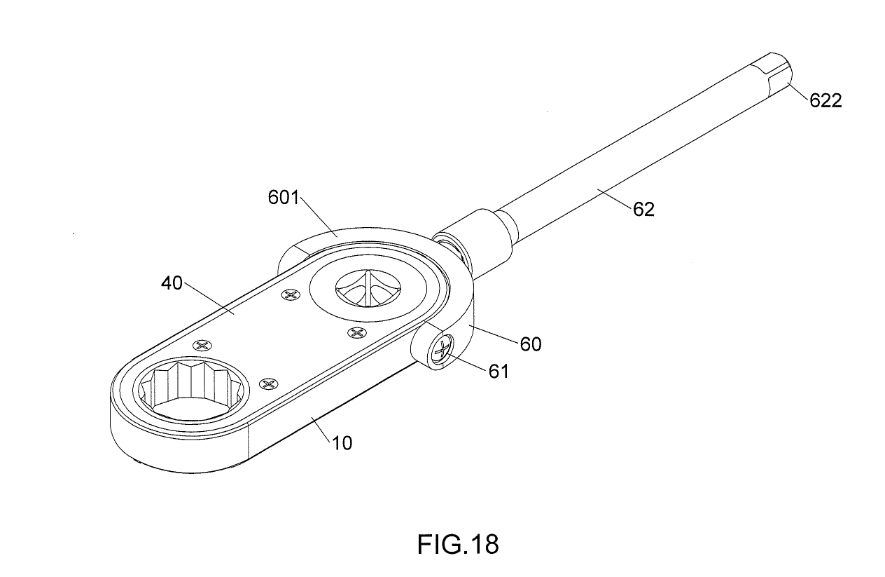

As shown in FIGS. 17 and 18, the first body 10 includes a first pivotal portion 16 on each of two sides thereof. The axis of each first pivotal portion 16 passes through the axis of the first recess 11. A second body 60 includes a U-shaped space 601 in which one end of the first body 10 is received. The first recess 11 is located in the U-shaped space 601. A third connection portion 602 extends from the outside of the second body 60. A second pivotal portion 603 is defined in each of two sides of the second body 60. The first body 10 is pivotably connected between the two second pivotal portions 603 by two pivots 61 extending through the second pivotal portions 603 and the first pivotal portions 16. The pivot 61 extends through the second pivotal portion 603 and the first pivotal portion 16. A cylindrical third body 62 includes a fourth connection portion 621 on the first end thereof. The fourth connection portion 621 is a rectangular recess. The third connection portion 602 is engaged with the fourth connection portion 621. The third body 62 has fifth connection portion 622 on the second end thereof. The fifth connection portion 622 is located opposite to the fourth connection portion 621.

The advantages are that when the first gear 20 or the second gear 2 is rotated, the at least one third gear 35 is rotated.

As shown in FIG. 9, the tools can be connected to each other to rotate the threaded member 64.

As shown in FIGS. 10 to 12, the third tool 73 is connected to the first gear 20 and the second tool 72 to prolong the whole assembly. The second mounting hole 32 can be connected with the fourth tool 74, or the sixth tool 76. The fourth engaging portion 741 is connected to a tool with the same rectangular protrusion. The seventh engaging portion 761 is able to be connected to a tool with the rectangular recess. As shown in FIGS. 9 to 12, when the second tool 72 is rotated, the second mounting hole 32 of the second gear 30 rotates the object connected thereto such as the threaded member 64, the fourth tool 74 or the sixth tool 76. The other hand of the user holds the first tool 71 to support the torque when the second tool 72 is rotated, therefore, the first body 10 does not spin because the torque from the second tool 72. The first, second, third, fourth, and sixth tools 71, 72, 73, 74 and 76 can be connected to obtain more ways of use.

As shown in FIGS. 15 and 16, the multiple third recesses 13 and the third gears 35 can prolong the operational length of the first body 10.

As shown in FIG. 18, the second body 60 is connected to the first body 10, and the angle between the first and second bodies 10, 60 can be adjusted.

While we have shown and described the embodiment in accordance with the present invention, it should be clear to those skilled in the art that further embodiments may be made without departing from the scope of the present invention.

What is claimed is:

1. A tool attachment comprising:
a first body having a first recess, a second recess and at least one third recess which is located between and in communication with the first and second recesses, the first body having a rectangular first connection portion;
a first gear rotatably received in the first recess and having first teeth defined in an outer periphery thereof, a first mounting hole defined in a center thereof;
a second gear rotatably received in the second recess and having second teeth defined in an outer periphery thereof, a second mounting hole defined in a center thereof;
at least one third gear rotatably received in the at least one third recess and having third teeth defined in an outer periphery thereof, the third teeth engaged with the first and second teeth so that the first gear drives the second gear via the at least one third gear, an axial hole defined in a center thereof;
a cover mounted to the first body by multiple bolts so as to position the first gear, the second gear and the at least one third gear in the first body, the first mounting hole and the second mounting hole being exposed from the first body;
an elongate first tool having a rectangular first engaging portion formed on a first end thereof, the first engaging portion engaged with the first connection portion;
a second tool having a rectangular second engaging portion which is cooperated with a ratchet unit;
an elongate third tool having a rectangular third engaging portion on a first end thereof, the third engaging portion connected to the first mounting hole of the first body, a rectangular recess defined in a second end of the third tool and connected with the second engaging portion;
a hexagonal fourth tool connected to the second mounting hole and having a rectangular fourth engaging portion;
a fifth tool unit connected to the fourth tool and being a connector, and
a sixth tool connected to the second mounting hole of the second gear and having a seventh engaging portion protruding therefrom, the sixth tool being a connector.

2. The tool attachment as claimed in claim 1, wherein the at least one third recess is one third recess.

3. The tool attachment as claimed in claim 1, wherein the at least one third recess includes a closed end.

4. The tool attachment as claimed in claim 1, wherein a diameter of the first recess, a diameter of the second recess, and a diameter of the at least one third recess are the same, the first gear, the second gear and the third gear have an identical outer diameter.

5. The tool attachment as claimed in claim 1, wherein the axial hole is a round hole.

6. The tool attachment as claimed in claim 1, wherein the cover seals the third gear and hides the third gear in the first body.

7. The tool attachment as claimed in claim 1, wherein the fifth tool unit includes a fifth tool, a first pin, a second pin, a spring, a first bead, a second bead and a push member, the fifth tool has a rectangular fifth engaging portion on a first end thereof, the fifth engaging portion is connected to the fourth engaging portion, the fifth tool has a rectangular sixth engaging portion on a second end thereof, the fifth engaging portion includes a first bead hole, the sixth engaging portion includes a second bead hole and a first receiving portion, the first receiving portion communicates with the first bead hole and the second bead hole, the fifth tool includes a through hole located between the first bead hole and the second bead hole, an axis of the through hole is perpendicular to an axis of the first receiving portion, the first pin movably extends through the first receiving portion, the first pin has a first receiving recess in a first end thereof and the first receiving recess is located corresponding to the through hole of the fifth tool, a first notch is defined in a second end of the first pin, the first receiving recess opens laterally and has an inclined end face, the second pin extends through the first receiving portion and is engaged with the first pin, when the first pin moves in the fifth tool, the second pin is driven to move by the first pin, the second pin includes a second notch defined in a first end thereof, the spring is located in the first receiving portion and biased between the first receiving portion and the first pin, the first bead is located in the first bead hole and contacts the first pin, the first bead partially protrudes beyond the first bead hole, the second bead is located in the second bead hole and contacts the second pin, the second bead partially protrudes beyond the second bead hole, the push member is inserted into the through hole of the fifth tool and engaged with the first pin, the push member includes a second receiving recess which contacts the first receiving recess, the second receiving recess has an inclined face which is in contact with the inclined face of the first receiving recess, the push member has one end thereof protruding beyond the through hole of the fifth tool, when the push member is pushed, the second receiving recess pushes the first receiving recess, the first pin drives the second pin to move in the fifth tool, and the spring is compressed, the first bead is received in the first notch and submerged in the first bead hole, the second bead is received in the second notch and submerged in the second bead hole, the second pin has one end protruding beyond the first receiving portion, the sixth engaging portion is adapted to be connected to or dis-connected from a tool, the fifth engaging portion is separated from the fourth engaging portion.

8. The tool attachment as claimed in claim 1, wherein the first body has a rectangular protrusion extending therefrom which is adapted to be connected with an extension rod.

9. The tool attachment as claimed in claim 1, wherein the at least one third recess is defined through the first body, the axial hole is a hexagonal hole, the cover includes a third hole which is located corresponding to the at least one third recess, the axial hole is exposed.

10. The tool attachment as claimed in claim 1, wherein there are two third recesses and two third gears, a diameter of each of the third recesses is smaller than a diameter of the first recess and a diameter of the second recess, two tubular pivotal members respectively extend from the two third recesses, the two third gears are mounted to the two pivotal members, the third teeth of the two third gears are engaged with the first teeth of the first gear and the second teeth of the second gear.

11. The tool attachment as claimed in claim 1, wherein the first body includes a first pivotal portion on each of two sides thereof, an axis of each first pivotal portion passes through an axis of the first recess, a second body includes a U-shaped space in which one end of the first body is received, the first recess is located in the U-shaped space, a third connection portion extends from an outside of the second body, a second pivotal portion is defined in each of two sides of the second body, the first body is pivotably connected between the two second pivotal portions by two pivots extending through the second pivotal portions and the first pivotal portions, a cylindrical third body includes a fourth connection portion on a first end thereof, the fourth connection portion is a rectangular recess, the third connection portion is engaged with the fourth connection portion, the third body has fifth connection portion on a second end thereof, the fifth connection portion is located opposite to the fourth connection portion.
